(19) United States
(12) Patent Application Publication
(10) Pub. No.: US 2009/0268794 A1
(43) Pub. Date: Oct. 29, 2009

(54) COMMUNICATION SYSTEM AND METHOD FOR OPERATING A COMMUNICATION SYSTEM

(75) Inventor: Wolfram Drescher, Dresden (DE)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP, B.V., Eindhoven (NL)

(21) Appl. No.: 12/438,303

(22) PCT Filed: Aug. 20, 2007
(86) PCT No.: PCT/IB07/53317

§ 371 Date: Feb. 20, 2009

(30) Foreign Application Priority Data
Aug. 21, 2006 (EP) 06119262.1

(51) Int. Cl. H04B 1/38

(52) U.S. Cl. 375/220

(57) ABSTRACT

The invention relates to a communication system (1), comprising a digital interface (2) for transmitting data between a medium access control subsystem (3) and a physical layer (4), furthermore comprising at least a vendor specific register (10.3) integrated into the physical layer (4) and accessible by said medium access control subsystem (3) for controlling the physical layer (4), and furthermore comprising at least a system register (9) integrated into the physical layer (4), wherein:—the system register (9) is accessible by the medium access control subsystem (3) via the vendor specific register (10.3).

The invention relates to a communication system especially to a digital communication system for transmitting data from a medium access control subsystem via a digital interface to a physical layer and to an antenna and vice versa. Furthermore the invention relates to a method for operating such a communication system.

Communication systems are used in particular in wireless ultra-wideband communication devices (shortly called UWB transmitter, with UWB=ultra-wideband). The communication system may be part of a transceiver, such as of an ultra-wideband transceiver which could be integrated in several electronic devices such as in pocket PCs, in mobile phones, in digital cameras, etc. The UWB technology is a wireless radio technology for transmitting data point-to-point between consumer electronics, computer peripherals and mobile devices within short range at very high speeds, while consumer little power. UWB transceivers are designed specifically according to the MBOA (MultiBand OFDM Alliance) guidelines described a digital interface between implementations of the physical layer (shortly called PHY) and the medium access control (shortly called MAC). The digital interface is intended for applications with a medium access control device resided on a separate chip from the physical layer, wherein the digital interface may be designed as an internal interface. The technical specification for the digital interface (shortly called MAC-PHY interface) between the medium access control subsystem or device and the physical layer are described for instance in the standard ANSI/IEEE Std 802.11-1999 and in the MultiBand OFDM Physical Layer Specification, Release 1.0, Apr. 27, 2005, MultiBand OFDM Alliance (MBOA) Special Interest Group (SIG). This standard defines the protocol and compatible interconnection of wireless data communication equipment via radio or infrared, e.g. in a local area network. According to the standards, the MAC-PHY digital interface consists of a data interface including an 8-bit wide data bus, a control interface, a clear channel assessment interface (=CCA interface) and a serial management interface. Especially the technical specification limits the digital interface for an external access to the so called serial management interface (shortly called SMI). This serial management interface is a standardized method to access register files of the physical layer. Furthermore, the serial management interface is a common interface and offers limited speed. As a common interface the serial management interface may be used for other purposes like debugging, monitoring locations and states of the physical layer and/or booting.

Normally, the physical layer boot access as well as debug access and test access is done by additional proprietary serial and/or parallel interfaces connected to external peripherals or electronic units. These other parallel and/or serial interfaces are connected the physical layer to external environments. If a memory block implemented in a base band of the physical layer shall be booted, this memory block is directly connected to the medium access control subsystem or a host device via such additional parallel interface. These other external interfaces require extra effort for connecting them with the physical layer and/or the medium access control and are designed for different applications and functions e.g. as a boot interface for memories, a debug interface for access to distinguished registers or busses or for access to monitor points inside the physical layer for real-time testing.

It is thus an object of this invention to specify a communication system by which it is possible to access memories integrated in the physical layer without additional hardware interfaces.

The problem is solved by a communication system comprising the features given in claim 1 and by a method for operating such a communication system comprising the features given in claim 10.

Advantageous embodiments of the invention are given in the respective dependent claims.

The communication system comprises a standard digital interface for transmitting data between a medium access control subsystem and a physical layer. Furthermore the communication system comprises at least a vendor specific register and at least a system register, both integrated into the physical layer. The vendor specific register is accessible by said medium access control subsystem for controlling the physical layer via the digital interface. According to the invention, the system register is accessible by the medium access control subsystem via an advanced vendor specific register and the digital interface.

The dual-use of the standardized digital interface for accessing the system register by the medium access control subsystem allows an external access to the physical layer without other external interfaces than the standardized digital interface. By such a dual-use of the vendor specific registers contained in the digital interface a single configurable interface is designed that connects the physical layer device to any standard medium access control device or host system without any other hardware interfaces. The access via the new designed vendor specific register may be easily structured and controlled through the standard access digital interface or channel from the medium access control subsystem to the physical layer subsystem. This enables access to several system register via the standardized digital interface without additional hardware.

Advantageously, the medium access control subsystem is connected to the vendor specific register via a serial data management interface contained in the digital interface. The serial data management interface allows a register access to the vendor specific registers initiated by the medium access control with control parts and address parts for reading and writing.

In a possible embodiment, the vendor specific register is connected to the system register. In particular, the vendor specific register is directly connected to the system register. Alternatively or additionally, the vendor specific register is indirectly connected to the system register via an address decoder or a block register.

In a sophisticated embodiment of the invention, the vendor specific register serves as a parallel data interface comprising an 8-bit wide parallel data bus and a 16-bit wide address bus. The first register is the 8-bit wide data value register for reading or writing data from consecutive memory addresses. The next two registers are 8-bit wide address registers to form a 16-bit wide address indexing consecutive addresses in the respective system register.

To control write and read operations in or from the system register the parallel data interface comprises at least one control register. Furthermore, the control register allows controlling boot or reconfiguration procedures, debugging procedures and/or monitoring procedures using access to the system register. Hence, the parallel data interface serves for debugging different subsystems of the physical layer and/or booting or reconfiguring the physical layer during an operation time.

In a further advantageous embodiment, the system register is a random access memory. Alternatively or additionally, the system register is an address decoder or block register. The system register may be part of a subsystem of the physical layer, e.g. of a functional block in a transmit path or in the receive path.

With regard to the method for operating a communication system, the medium access control subsystem accesses the system register via the vendor specific register. In more detail, the serial data management interface contained in the digital interface is used for connecting the medium access control subsystem with the vendor specific register. In a READ cycle, the medium access control subsystem writes addresses addressing the system register addresses in at least two 16-bit wide address registers of the vendor specific register and reads data from the respective system register addresses via an 8-bit wide data value register contained in the vendor specific register. In a WRITE cycle, the medium access control subsystem writes addresses addressing the system register addresses in at least two 16-bit wide address registers of the vendor specific register and writes data to the respective system register addresses via an 8-bit wide data value register contained in the vendor specific register.

The present invention has the advantages of a simple hardware by reusing the existing standard digital interface for accessing system registers for different functions such as debugging, booting and monitoring. Thus, an external interface is not needed. Such an advanced standard digital interface is especially useable for a wireless ultra-wideband communication system. Although, the above solution is proposed for a transmit system in communication devices, especially for an UWB transceiver or transmitter.

In the following, the invention is explained in further detail with a drawing.

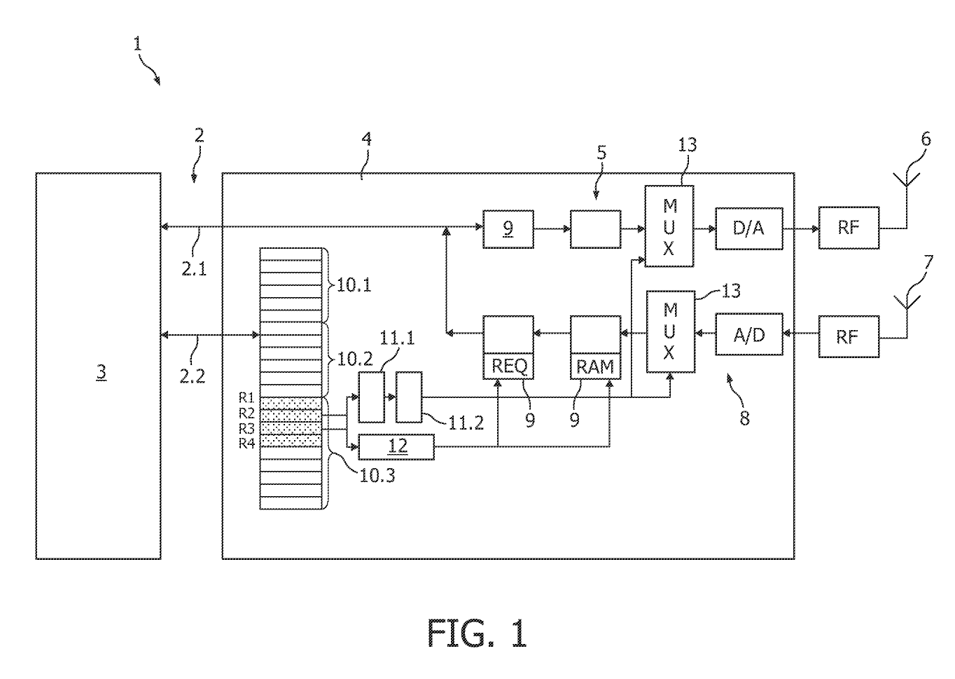

FIG. 1 shows a block diagram of a communication system reusing a digital interface for accessing a system register by a medium access control subsystem,

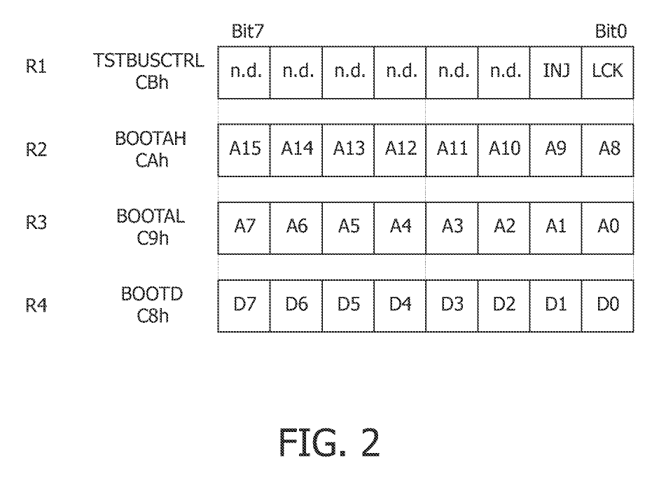

FIG. 2 shows a possible embodiment for a design of a vendor specific register contained in the digital interface,

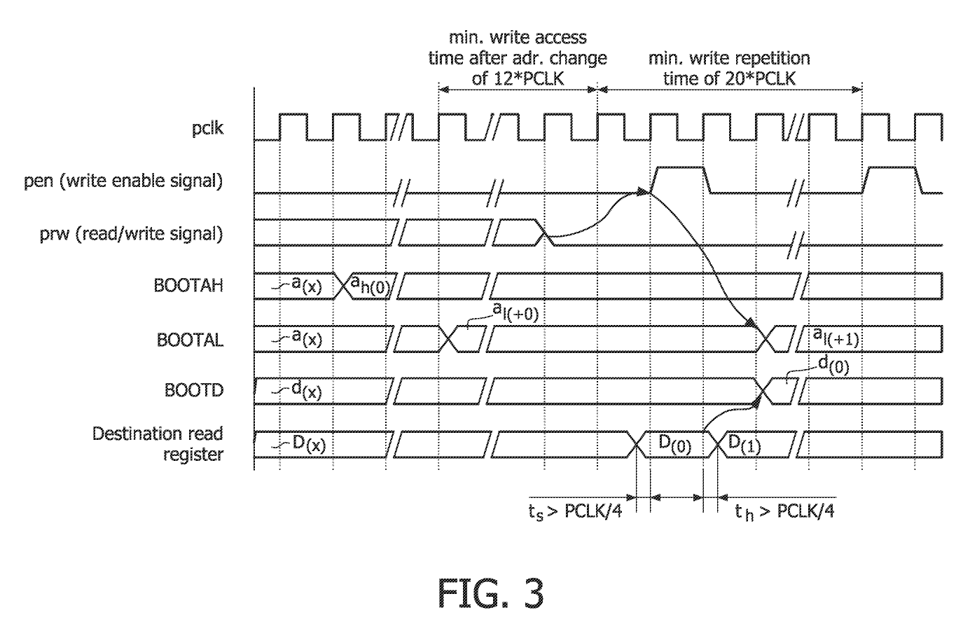

FIG. 3 shows a functional diagram of a read process via the digital interface,

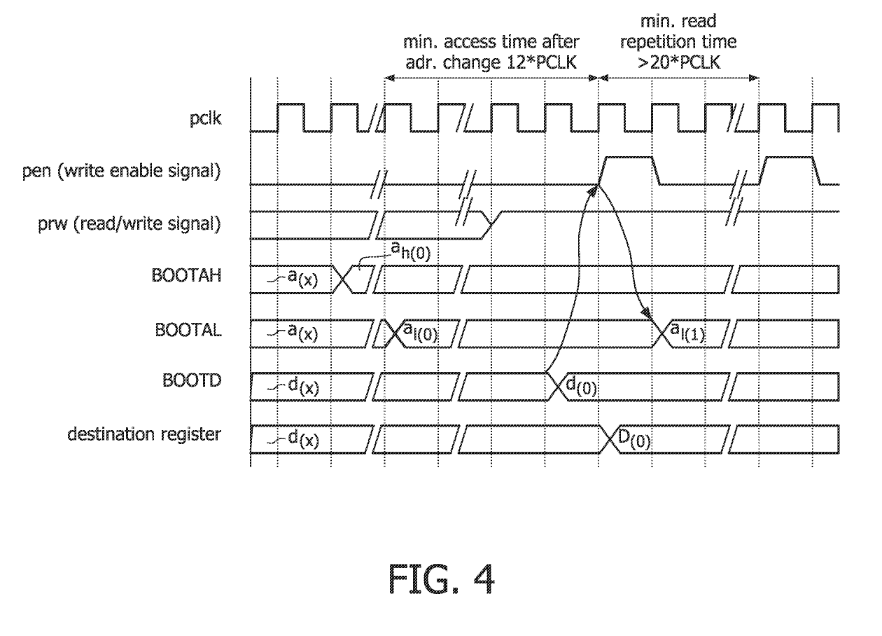

FIG. 4 shows a functional diagram of a write process via the digital interface.

FIG. 1 shows a general block diagram of an ultra-wideband communication system 1.

The communication system 1 is used in particular in wireless communication devices. The communication system 1 could be part of a transceiver, such as of an ultra-wide band transceiver which could be integrated in several electronic devices such as in pocket PCs, in mobile phones, in digital cameras, etc.

The communication system 1 comprises a digital interface 2 for transmitting data from a medium access control device 3 to a physical layer 4 via a transmit path 5 to an antenna 6 into a transmission line and from the transmission line from an antenna 7 via a receive path 8 of the physical layer via the digital interface 2 back to the medium access control device 3. Furthermore, the physical layer 4, especially one or more functional blocks of the transmit path 5 and/or the receive path 8 comprises system registers 9, such as a random access register or block register.

The digital interface 2 consists of at least a data interface 2.1 including an 8-bit wide data bus and at least a serial management interface 2.2 including a configurable parallel interface. Via the data interface 2.1 valid data are transmit or received between the physical layer 4 and the medium access control device 3 via the transmit path 5 or the receive path 8 to the respective antenna 6 or 7. The serial management interface 2.2 is used for accessing a plurality of register 10.1 to 10.3 of the digital interface 2 integrated in the physical layer 4. The serial management interface 2.2 controls and addresses write and read operations to these registers 10.1 to 10.3.

At least three sets of registers 10.1 to 10.3 are defined to allow the medium access control device 3 to control operations of the physical layer 4 and permit information to be provided by the physical layer 4 to the medium access control device 3.

A first set of registers 10.1 defines static parameters for given instantiation of the medium access control device 3 and the physical layer 4. A second set of registers 10.2 defines dynamic parameters changed during operation of the communication system 1 and affected operations and states of the physical layer 4. These static and dynamic parameters are defined according to standard guidelines mentioned above.

A third set of registers 10.3 defines vendor specific register to access register files in the physical layer 4. According to the invention, a plurality of these vendor specific registers 10.3 is dual-used. These dual-used vendor specific registers 10.3 define a new parallel single interface which allows an access to the system register 9 of the physical layer 4 by the medium access control 3. In detail, the dual-used vendor specific registers 10.3 serves as a parallel data interface consists of an 8-bit wide parallel data bus and a 16-bit wide address bus.

In FIG. 2 the advanced vendor specific registers 10.3 are shown in more detail. The new access and control of the parallel single interface is done via at least four registers contained in the vendor specific registers 10.3 of the serial management interface 2.2 contained in the digital MAC-PHY interface 2. According to the used function, such as booting function, debugging function, monitoring function, these dual-used vendor specific registers 10.3 are respectively advanced. For instance for a booting function those registers 10.3 are:
a first register R1 for monitoring and controlling a testbus via a testbus control signal “TSTBUSCTRL”, two LSB bits “INJ” and “LCK” control the monitor modes (monitoring/injection) for the testbus;
a second register R2 for addressing a high address “BOOTAH” (=Boot address high) is a 8-bit wide value address representing bits A14:A8 of the address of the destination system register;
a third register R3 for addressing a low address “BOOTAL” (=Boot address low) is a 8-bit wide value address representing bits A7:A0 of the address of the destination system register
a fourth register R4 for valid 8-bit data value “BOOTD” (=Boot data) reading or writing in or from the destination register addressed by the second and third registers R2, R3.

The vendor specific registers R1 to R4 of the serial management interface 2.2 are used for booting the communication system 1 before operating in normal mode or for reconfiguration of the communication system 1 initiated by the medium access control 3 between two frames during normal operations. Moreover, if the serial management interface 2.2 is in read mode, one can read all attached system registers 9 or memory partitions for the purpose of debugging.

The parallel interface realized by the four vendor specific registers R1 to R4 can only be accessed by the serial management interface 2.2. The digital interface 2 derives the control for the parallel interface from the serial management interface activity. In case via the serial management interface 2.2 the medium access control 3 writes valid data in the register R4 “BOOTD”. The digital interface 2 waits until the value in the register R4 “BOOTD” is complete before it initiates the control register R1 for a testbus parallel write access. This write access is completely under control of the digital interface 2, meaning the generation of signal for distinguishing read/write (“prw”-signal) and the generation of enable signal (“pen”-signal) for register access will be done in the register block 10.1, 10.2.

For decoding the destination addresses in the address registers R2 and R3 an address register 11.1 with added decoder logic 11.2 and/or an address decoder 12 are connected with the respective address register R2 and R3 of the vendor specific registers 10.3 and with the respective system registers 9. However, the decoder logic 11.2 and/or the address decoder 12 for destination system registers are distributed over several system registers 9 and multiplexer 13.

In case the digital interface 2 accesses the data register R4 “BOOTD” in read mode (see FIG. 3), the digital interface 2 or the so called MDI translates this read access into a read access to the parallel single interface with the new dual-used registers R1 to R4. When the mode reading or writing data from or to one of the system register 9 is asserted, MDI will generate the appropriate signals reading/writing signal “prw” (read/write enable) and writing signal “pen” (write enable) in order to read or write the destination system register 9 connected to parallel boot interface contained the vendor specific register R1 to R4 on the addresses “BOOTAH”, “BOOTAL” addressing in the register R2 and R3. With a delay of one cycle the read or write data will be put into valid data register R4 before MDI starts sending the data value via the serial management interface 2.2 to the medium access control 3.

This approach is feasible, since standard MAC/PHY specification allows the serial management interface 2.2 in read mode a period of max. 32 cycles between reception of the read address and the transmission of the read data value.

If the data register R4 “BOOTD” is written in read mode as well as in write mode, at the next cycle the low address register R3 “BOOTAL” will be incremented by 1. This is useful if a sequence of data has to be put into a system register 9 of consecutive addresses. Hence, a start address is to write into the low address register R3 “BOOTAL” before writing consecutive data into the data register R4 “BOOTD”.

The value of the low address register R3 “BOOTAL” is wrapped until it reaches the value FFh. The value of the high address register R2 “BOOTAH” is not wrapped after it reaches the value FFFFh. Furthermore, the address registers R2 “BOOTAH” and R3 “BOOTAL” and the data register R4 “BOOTD” do not have a shadow register. Hence, always if registers R2 to R4 written via MAC-PHY serial interface 2, a new value will be transferred to the destination address of the respective system register 9 with a consecutive increment of registers R2 “BOOTAH” and R3 “BOOTAL”. This mechanism speeds up the boot/reconfiguration procedure, because the device may get booted or reconfigured without having the need of transferring new values from shadow register to original register by activating a new TX or RX phase.

In summary, the advanced parallel boot interface contained the register R1 to R4 may be used for booting or reconfiguration certain building blocks of the digital base band of the physical layer 4 like:
predistortion coefficient memory of block PRP in transmitting path 5, consisting of a set of 6-bit wide coefficients;
Wiener filter coefficients in block EQU in receive path 8, consisting of wide values;
Read out memories and registers 9 of the physical layer 4 for debug purpose.

FIG. 3 shows a functional diagram of a read process via the digital interface 2. The medium access control 3 should first write an 8-bit wide address to the high address register R2 “BOOAH” via the serial management interface 2.2. Then the 8-bit wide address for addressing the destination system register 9 is written into the low address register R3 “BOOTAL”. Both address registers R2 and R3 form a 16-bit wide address addressing the address space of a set of system memories and/or system registers 9 contained in the digital physical layer 4.

Next action for the medium access control is to read the data register R4 “BOOTD”. The valid data cannot directly be accessed in the system register 9. A read access to the data register R4 BOOTD triggers a read process on the parallel interface 2.2 with addresses addressed in the address registers R2, R3 BOOTAH/L indexing the destination system register 9. This read process starts with setting the direction of access by asserting signal read/write-signal “prw” to 0′. Two clock cycles later the enable read signal “pen” is asserted in order to clock synchronous system memories 9 attached to the parallel interface 2.2. The data output of synchronous system memories 9 may not be available until the negative edge of the signal “pen”. It takes one more cycle to transmit the memory data to the data register R4 “BOOTD”. Altogether a read cycle takes for instance four cycles of PCLK cycle. Since destination system registers 9 are connected by a combinatorial network, they do not react to the assertion of the enable write signal “pen”. The address decoders 11.2 or 12 decode the destination system register 9 after a change of the address in the address register R2 and R3. However, the timing is the same as for memory components.

The specification of the MBOA MAC-PHY serial service bus allows a gap of up to 32 unused cycles until the physical layer 4 puts the requested read value on the serial interface 2.2. This allows the parallel interface to insert unused cycles for the time the data from the destination register 9 are read. In parallel the address register R2 and R3 are incremented in order to allow a consecutive read process without keeping the medium access control 3 busy with calculating the next address. At the end of the read process the desired data from destination system register 9 with data D(0) will appear in the data register R4 before it is transferred via the serial interface 2.2 to the medium access control 3.

Altogether, a complete read cycle for the medium access control 3 takes 26 PCLK cycles:
20 PCLK cycles of serial management interface read access and
4 PCLK cycles for accessing the parallel interface on the physical layer contained the four register R1 to R4 and
2 PCLK cycles for processing in MDI.

After the medium access control 3 received the 8-bit data value, it may trigger another read process again by reading the data register R4. In case the medium access control 3 intends to read non-consecutive addresses it has to set new addresses into the address register R2 and R3 in addition.

FIG. 4 shows a functional diagram of a write process via the digital interface 2. The medium access control 3 writes an 8-bit wide address in the low address register R3 addressing the destination address of one of the system register 9. Then an 8-bit wide address is written in the high address register R2. In a next step, the medium access control writes 8-bit data value in the data register R4. This will trigger the internal interface 2.2 and will transfer the data to the destination system register 9 at the respective addresses addressing in the address register R2, R3 within one cycle. The write action to the data register R4 via the MBOA serial interface 2.2 indicates the parallel interface with the vendor specific registers 10.3 to write the destination system register 9.

FIG. 4 depicts the parallel interface write process timing diagram for writing a number of n target system registers 9.

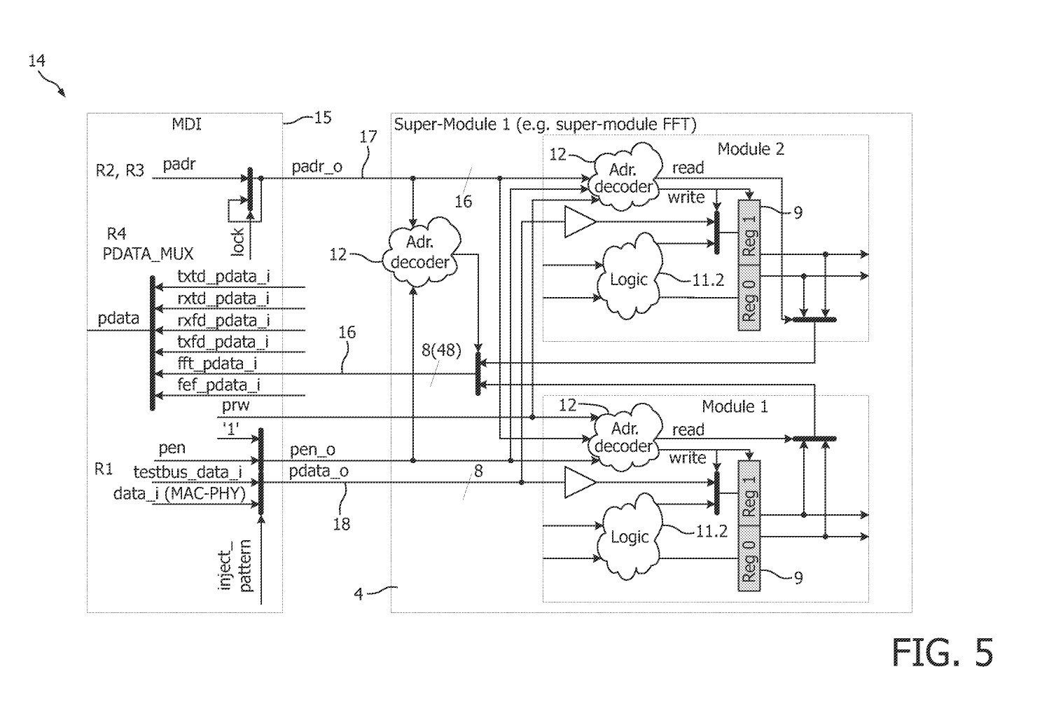

FIG. 5 shows a test-bus implementation system 14 with a block MDI containing the four registers R1 to R4 of the vendor specific registers 10.3 connected to address decoder 12 and/or address decoder logic 11.2 for decoding addresses in different system registers 9 with different functions such as for debugging, reconfiguration, etc. The vendor specific register 10.3, especially the register R1 to R4 serves as a parallel data interface 15 comprising an 8-bit wide parallel data test-bus 16 and a 16-bit wide address bus 17 and an 8-bit wide parallel control bus 19.

For debugging purposes the system 14 will be equipped with the 8 bit wide test-bus 16 for monitoring signals of a big variety of test points on the circuit. For Debugging one of a functional block of the physical layer, this test-bus 16 may be extended to 48 bit wide test-bus.

For testing functional blocks of the physical layer 4, an existing on chip multiplexer network of the parallel interface with the register R1 to R4 and the decoder logic 11.2, 12 will be dual-used.

Following steps will have to be performed to enable the test-bus 16:
1. Initiation of a test-bus access is done by accessing the parallel interface 15 with the register R1 to R4 over the serial management interface 2.2 of the MAC-PHY interface 2. In principle each register R1 to R4 attached to the parallel boot interface 15, which may work in read and write mode, could be accessed. The list of the accessible registers R1 to R4 is predefined.
2. The direction of the access of the MAC-PHY serial management interface 2.2 determines whether the target system register 9 is accessed in read or in write mode. That means, if the data register R4 is read by MAC-PHY serial management interface 2.2, the MDI asserts the access into a read access of the target system register 9 attached to the test-bus 16. If the data register R4 is written by the MAC-PHY serial management interface 2.2, the MDI asserts the access into a write access to the target system register 9 attached to the test-bus 16. The address for the target system register 9 is taken from the address register R2, R3 respectively.
3. On an ASIC, in read mode the decoded source of read address is put on the 8-bit wide test-bus 16 connected to 8 ASIC pins. In write mode, the value of the test-bus 16 is stored in the target system register 9, e.g. a memory cell.
4. On a FPGA, in read mode the decoded source of read address is put on a 48-bit test-bus 16 connected to FPGA pins. In write mode the value of the test-bus is stored in the target system register 9, e.g. a memory cell.
5. The source register address space is 16 bit wide (0000h . . . FFFFh).
6. Control register R1 “TSTBUSCTRL[0]” e.g. at address CBh in vendor register space locks the target test address and multiplexes the target register onto the test-bus 16. The address will not be destroyed by the next read access if it is locked.
   If the test-bus control signal “TSTBUSCTRL[0]” is active “TSTBUSLCK[0]=1”, the test-bus ports will be multiplexed to the last read source of the parallel bus. If the test-bus control signal “TSTBUSCTRL[0]” is inactive “TSTBUSLCK[0]=0”, the test-bus 16 may be attached to other sources. If the control register R1 according to the control signal “TSTBUSCTRL[0]” is on lock, the parallel interface 15 via the vendor specific register R1 to R4 does not have access in read mode.
7. Optionally, the a control bit “INJ” (=injection) of the control signal “TSTBUSCTRL[1]” may be asserted. If the control bit “INJ” equals “1”, data read from the test-bus pins of the chip will be routed to the internal injection point. If the control bit “INJ” is de-asserted and the test-bus 16 is locked, the test-bus 16 continues operation in monitoring or read mode.

A possible embodiment for an implementation of the test-bus 16 is shown in FIG. 5. Every important system register 9 which should be monitored gets an address assigned on the test-bus 16. For monitoring purpose, the target system registers 9 are accessible only in read mode. The test-bus 16 on an ASIC-based embodiment is 8-bit wide. The test-bus 16 on a FPGA-based embodiment is 48-bit wide in parallel.

Furthermore, due to the absence of bi-directional busses on chip, the test-bus data bus has to be divided into a read data bus and a write data bus. Both data busses are routed to the respective destination system register(s) 9 in the physical layer 4. The destination register 9 is connected to the busses via its proper inputs/outputs (for both directions read and write). The direction is controlled by signal “prw” (parallel bus read/write), which is generated inside the according parallel bus logic module in the MDI block. Signal “pen” (parallel bus enable) strobes the destination register 9 in write mode by generating a one cycle write pulse. Signal “inject pattern” selects the input “testbus_data_i” as source for data injection. The test-bus pins will then directly route data from the system register 9 into the data register R4.

1. Communication system, comprising a digital interfaces for transmitting data between a medium access control subsystem and a physical layer, furthermore comprising at least a vendor specific register integrated into the physical layer and accessible by said medium access control subsystem for controlling the physical layer, and furthermore comprising at least a system register integrated into the physical layer, wherein: the system register is accessible by the medium access control subsystem via the vendor specific register.

2. System according to claim 1, wherein the medium access control subsystem is connected to the vendor specific register via a serial data management interface contained in the digital interface.

3. System according to claim 1, wherein the vendor specific register is connected to the system register.

4. System according to claim 1, wherein the vendor specific register serves as a parallel data interface comprising an 8-bit wide parallel data bus and a 16-bit wide address bus.

5. System according to claim 4, wherein the parallel data interface comprises at least three registers, with two of them being address registers indexing addresses in the respective system register and one of them being an 8-bit data value register for reading and/or writing data.

6. System according claim 4, wherein the parallel data interface comprises at least one control register.

7. System according to claim 1, wherein the system register is a random access memory.

8. System according to claim 1, wherein the system register is an address decoder or block register.

9. System according to claim 4, wherein the parallel data interface serves for debugging of different subsystems of the physical layer and/or for booting or reconfiguring the physical layer during an operation time.

10. Method for operating a communication system, comprising a digital interface a for transmitting data between a medium access control subsystem and a physical layer, furthermore comprising at least a vendor specific register integrated into the physical layer and accessible by said medium access control subsystem for controlling the physical layer, and furthermore comprising at least a system register integrated into the physical layer, wherein:
the medium access control subsystem accesses the system register via the vendor specific register.

11. Method according to claim 10, wherein a serial data management interface contained in the digital interface is used for connecting the medium access control subsystem with the vendor specific register.

12. Method according to claim 10, wherein the medium access control subsystem writes addresses addressing the system register addresses in at least two 16-bit wide address registers of the vendor specific register and reads data from the respective system register addresses via an 8-bit wide data value register contained in the vendor specific register in a READ cycle.

13. Method according to claim 10, wherein the medium access control subsystem writes addresses addressing the system register addresses in at least two 16-bit wide address registers of the vendor specific register and writes data to the respective system register addresses via an 8-bit wide data value registered contained in the vendor specific register in a WRITE cycle.
